(19) United States
(12) Patent Application Publication
(10) Pub. No.: US 2014/0326806 A1
(43) Pub. Date: Nov. 6, 2014

(54) GRANTHAM MECHANICAL VENTILATOR FOR USE IN PREVENTING FLASHOVER WHEN FIGHTING FIRES

(71) Applicant: Robert Grantham, Schnecksville, PA (US)

(72) Inventor: Robert Grantham, Schnecksville, PA (US)

(21) Appl. No.: 14/116,399

(22) PCT Filed: May 1, 2012
(86) PCT No.: PCT/IB12/02613

§ 371 Date: Nov. 8, 2013

Related U.S. Application Data
(60) Provisional application No. 61/528,274, filed on Aug. 28, 2011.

(51) Int. Cl. A62C 31/24; B05B 15/06

(52) U.S. Cl. CPC A62C 31/24; B05B 15/061
USPC 239/525

(57) ABSTRACT

Disclosed is a mechanical firefighting device capable of operating unattended once it has been configured from the outside of a burning structure. With no firefighter presence required in the burning structure, the device removes heated air and smoke from the structure and allows the application of materials to douse the fire, thereby minimizing the occurrence of flashover, the simultaneous combustion of the contents of a burning compartment which causes a fire to burn out of control.

This utility patent application is being filed as a PCT application for consideration in all PCT member states, with the USPTO as the designated receiving office. The instant application claims priority from provisional application No. 61/528,274 filed in the USPTO on 26 Aug. 2011 whose entire contents are incorporated herein by reference.

### FIELD OF THE INVENTION

This invention relates to an improved tool and methods for its use by firefighters in minimizing the loss of human life and damage to property resulting from the phenomenon known to firefighters as “flashover.”

### SUMMARY OF THE INVENTION

Disclosed is a novel defensive firefighting tool which reduces the possibility of flashover. Its mode of action is to pull heat and smoke from the burning compartment, which is opposite to that of the typical approach to ventilating a burning compartment by blowing air into the structure by a fan to push the heat and smoke out. The Grantham Mechanical Ventilator reduces injury to humans at the scene as well as reducing property damage, by (1) pulling superheated air and smoke from the burning structure before flashover occurs and (2) optionally by dousing the flames directly with a sprinkler flow when appropriate. Additionally, the tool (3) reduces the spread of fire within the burning structure, (4) reduces the spread of fire to adjacent flammable exposures, and (5) facilitates escape by people trapped inside the burning structure. Finally, (6) once put in place the tool provides an unmanned means by which the preceding may be accomplished.

### DETAILED DESCRIPTION

As one skilled in the art of firefighting knows, flashover is the most dangerous time of a fire. When the contents of a burning room burst into flame simultaneously, flashover has occurred. Flashover is caused by the radiation feedback of heat. Heat from the growing fire is absorbed into the upper walls and contents of the room, heating up the combustible gases and furnishings to their auto-ignition temperature. This buildup of heat in the room triggers flashover, which signals: (a) the end of an effective search and rescue in a room; (b) the imminent death of any person, civilian or firefighter, trapped in the blazing room; (c) the end of being able to use a portable fire extinguisher, instead requiring an fire hose attached to a source of pressurized water; (d) the end of the fire's growth stage and that the fire is in the second stage of combustion—the fully developed stage; and finally, (e) the change from a contents fire to a structure fire.

Flashover is not consistently time-dependent. Some flashovers can occur within three minutes from ignition; others may take considerably longer. Flashover times are more dependent on the size of the compartment, the fuel load within the compartment, and the construction of the compartment. Again, these variables cannot be seen from outside the structure, so the interior firefighters and officers have to be constantly aware of them.

Flashover signals the beginning of the structural collapse danger. When operating at a fire, firefighters want to delay flashover inside a burning room. Delaying flashover can provide several extra minutes which may be critical. For example, you may want to delay flashover to make a search and rescue of the burning room or to allow a firefighter to go to a room above or next-to the fire to rescue a trapped victim. Or, you may want to delay flashover to gain several minutes when there is a delay in the placement of the first fire hose.

The first tactic that can delay a flashover is to ventilate the compartment. This allows heat and heated gases to escape from the compartment, replacing them with cooler air at a rate faster than the heat and gases replenished by the combustion taking place. Ventilation serves to delay flashover when done quickly and effectively.

The second tactic that can delay a flashover is to close off the compartment. By closing a door in the room that is experiencing pre-flashover conditions, air cannot enter as readily. This can decrease the rate of burning in the room, delaying the flashover. By closing a door, you are also taking the imminent flashover out of the surrounding area so that other nearby rooms can be searched in a safer manner for a longer time.

The final way that a flashover can be delayed is by cooling the atmosphere with water, high in the compartment. This would have to be done with a fire hose or water-based fire extinguisher. By aiming the stream of water into the high heat layer, the gases are cooled. This reduction in temperature slows the process of flashover within the compartment. This technique has the disadvantage of causing an increase in steam buildup that can hinder vision within the burning compartment.

The indications of a potential flashover may include a growth stage fire that produces thick and dark smoke, high heat buildup, and rollover. A growth stage fire must exist, even though it may be partially or completely obscured by walls, furniture, and thick smoke. This is the only way the heat needed to flashover can be produced within a compartment. Thick and dark smoke indicates the fuels that are present are giving off vapors that can burn when exposed to high heat. The heat is intense and can build up quickly.

Heat: When heat mixes with smoke, it forces a firefighter to crouch down on hands and knees to enter a room to perform search and rescue. This must be considered a warning sign that flashover may occur, as heat is the triggering variable for flashover. If the heat in the smoke filled room causes firefighters to crouch down near the floor, flashover may be imminent.

Rollover: Rollover is the ignition of the accumulated gases that have collected at ceiling level. This may start off as a sporadic burst of orange flames and build up in frequency and intensity to a “sea” of orange flames overhead. Again, this may be partially obstructed by the smoke, but it can usually be seen by those who look for it. The intense rollover condition, characterized by the sea of orange overhead, is usually considered a late sign of an impending flashover.

Protective Equipment: With all of the advancements in today's firefighter's personal protective equipment, it is still not designed to withstand flashover conditions for longer than just a few seconds. A few seconds may save a firefighter's life if he or she takes fast and appropriate action, but the gear will fail quickly when exposed to the temperatures commonly found in flashover conditions, between 1,000° F. and 1,500° F.

Taking a proactive approach: Rather than send firefighting personnel into a burning structure to assess whether flashover is imminent, the instant invention allows the conditioning of the environment in the compartment being entered to reduce the chances of flashover by removing built-up heat and smoke prior to entry, as well as allowing the dousing of the flames with water when appropriate. An additional benefit of removing smoke buildup is increased visibility, allowing a more accurate assessment of the situation therein, further increasing the safety factor. Additionally, the Grantham Mechanical Ventilator requires neither that a firefighter enter the burning building to put it in position nor remain in the building to operate it, thereby further decreasing the risk to firefighters.

Using the Grantham Mechanical Ventilator: The Officer of the first arriving fire engine, after confirming that all humans are out of the burning structure by a complete evaluation of the scene, determines the point of origin of the fire and to help reduce dangers to his or her crew, orders that the Grantham Mechanical Ventilator be used in the compartment that is the point of origin of the fire. The tool is then secured to the top of a ladder with the fire hose connected to the device's water input and positioned through the opening into the burning structure so that the sprayer circuit input is outside the structure and fog sprayer output nozzle is inside the structure pointing outward. If the attic compartment is the only area needing emergency ventilation, then an opening large enough to allow fog pattern effectiveness must be made before inserting the mechanical ventilator. A firefighter then (1) climbs the ladder and clears away the remaining glass and debris from the window frame, (2) signals to the pump operator to turn on the water, (3) activates the tool's sprinkler for five to 10 seconds if appropriate, then (4) adjusts the water flow outward from the ventilating fog nozzle to optimize it for the size of the window opening through which it is inserted. Once configured, the device requires no further attention. Note that a preferred embodiment of the instant invention can apply water spray to suppress a fire, but the tool may also be configured to apply foam or other fire suppression materials as well.

How it works: In essence, the cool water fog stream pulls the heat and smoke from the burning compartment in a manner akin the way one racing car “drafts” another, with the front car creating a partial vacuum which in effect pulls the following car along. In this case, the fog stream is analogous to the lead car and the hot air/smoke mixture is the following car. In addition, the fog, being much cooler than the heated air in the compartment and in a high state of division as tiny droplets, presents a highly effective heat sink into which the heat flows due to basic thermodynamic principals.

In the Grantham Mechanical Ventilator, the distance from the outlet of the fog nozzle to the opening in the side of the burning building can vary. In a preferred embodiment, the distance is three feet.

Protecting adjacent exposures from flashover: The Grantham Mechanical Ventilator, by suppressing flashover, protects adjacent exposures (combustible materials) located near the burning building by suppressing the ejectment of flames and radiant heat from the burning structure that typically occurs during flashover. Additionally, the fog serves to douse any incipient combustion by cooling and dampening any nearby adjacent exposures.

In another preferred embodiment, the Grantham Mechanical Ventilator will possess a forcible-entry mechanism.

### BRIEF DESCRIPTION OF THE FIGS.

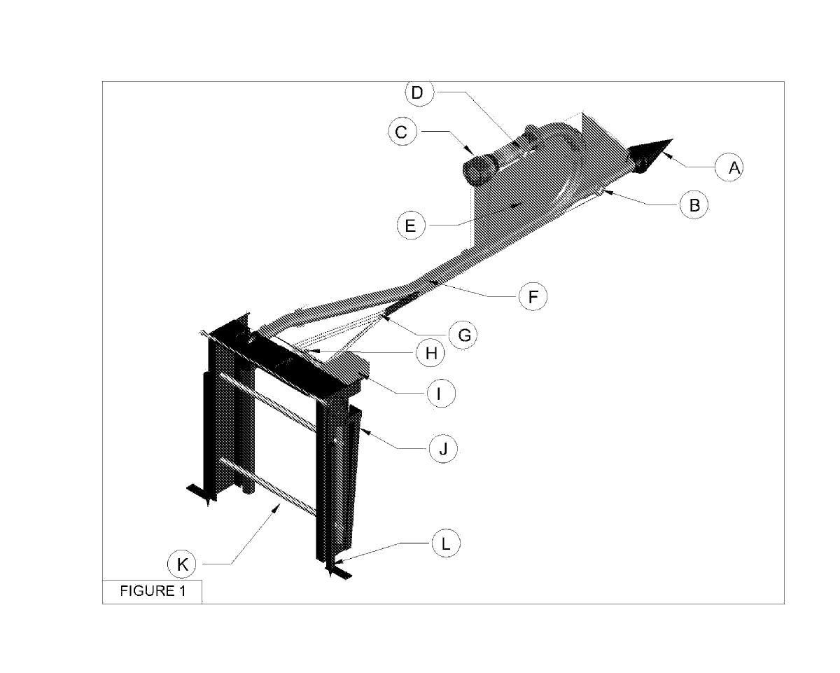

FIG. 1: Top right-rear view of internal structure and ladder mounting mechanism.

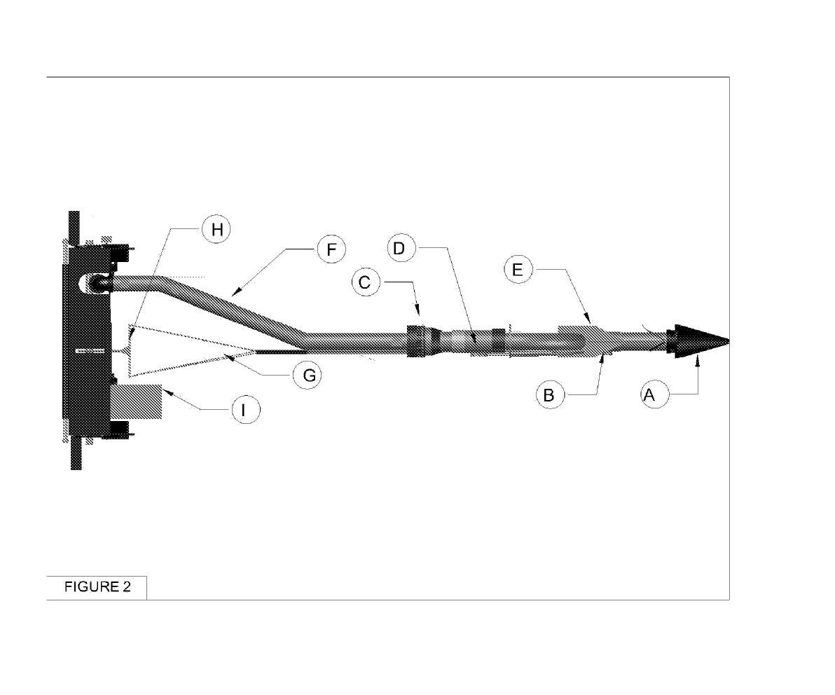

FIG. 2: Top view of internal structure and ladder mounting mechanism.

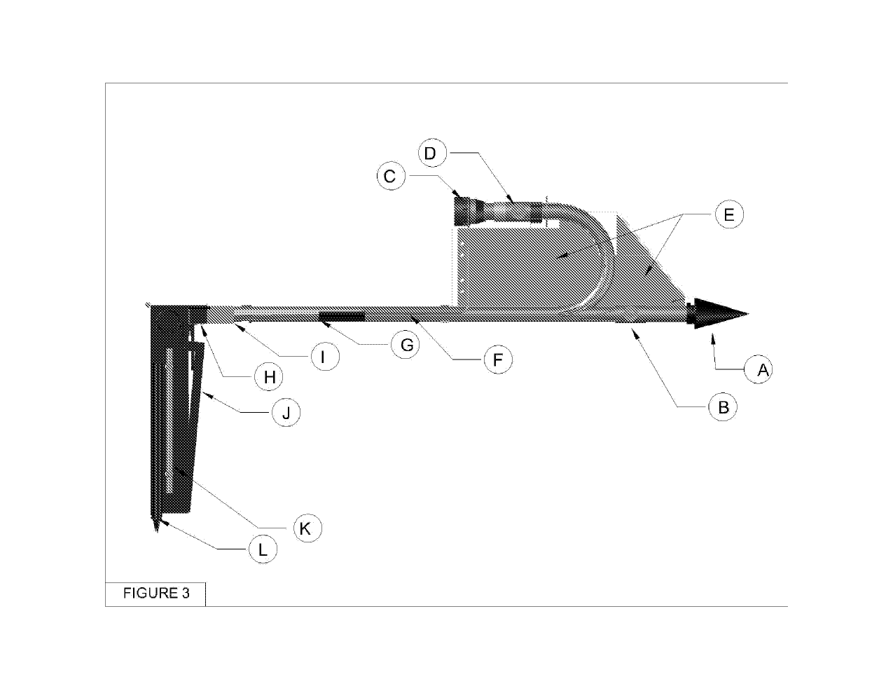

FIG. 3: Right side view of internal structure and ladder mounting mechanism.

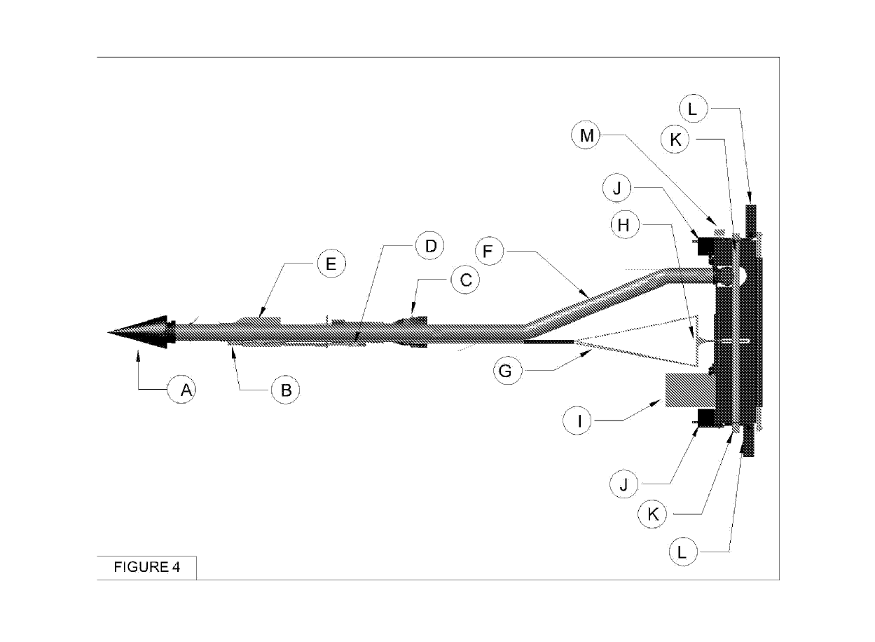

FIG. 4: Bottom view of internal structure and ladder mounting mechanism.

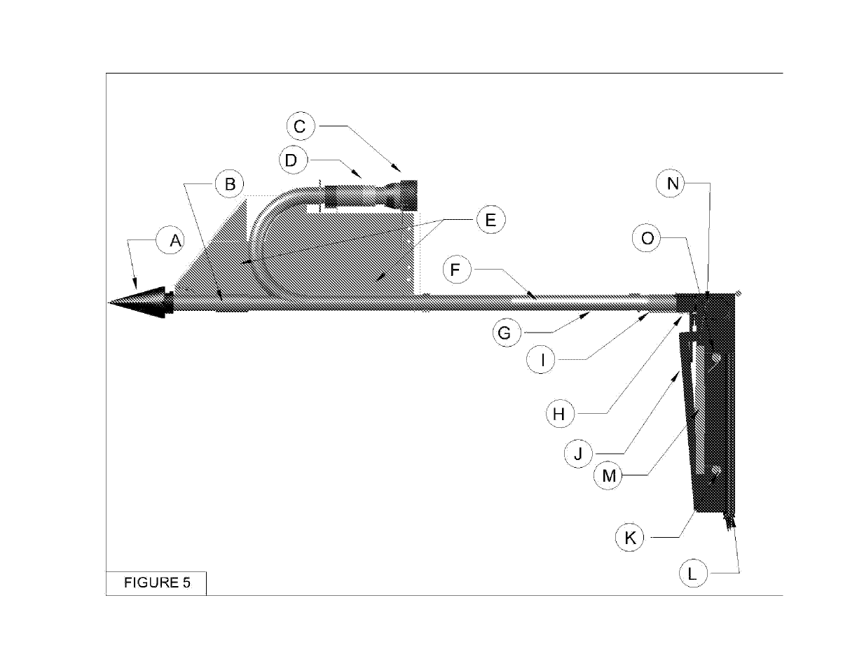

FIG. 5: Left side view of internal structure and ladder mounting mechanism.

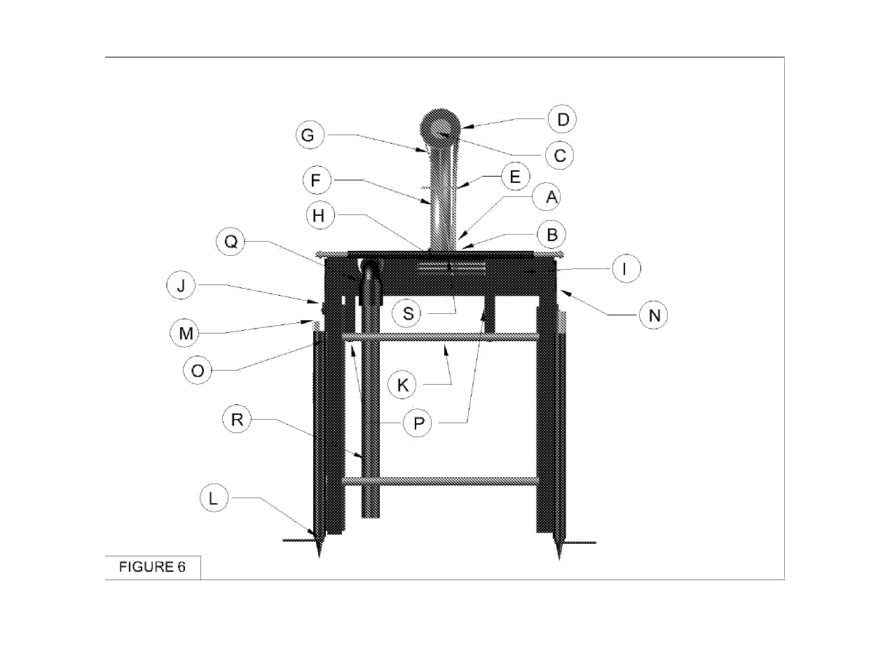

FIG. 6: Rear view of internal structure and ladder mount mechanism.

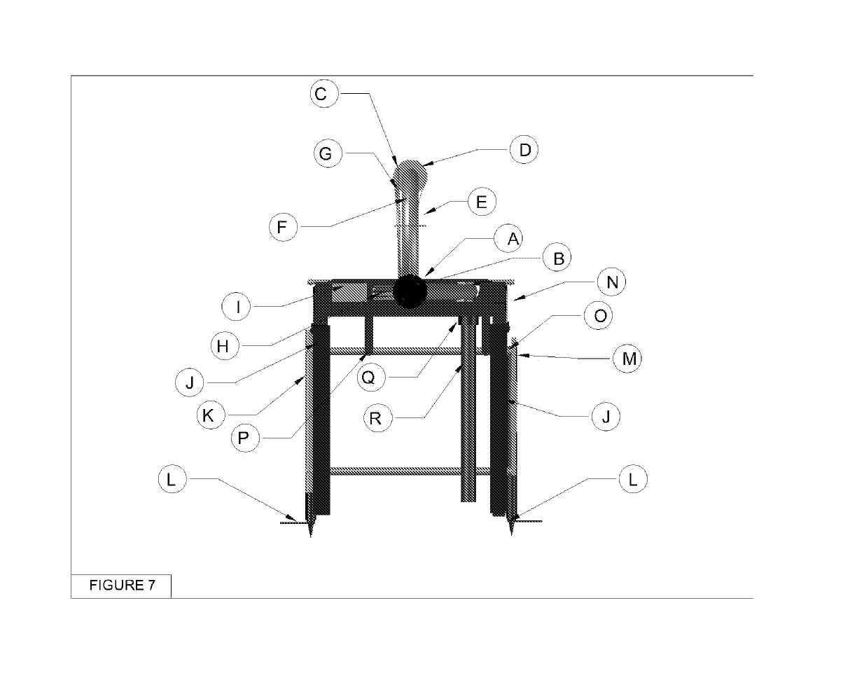

FIG. 7: Front view of internal structure and ladder mount mechanism.

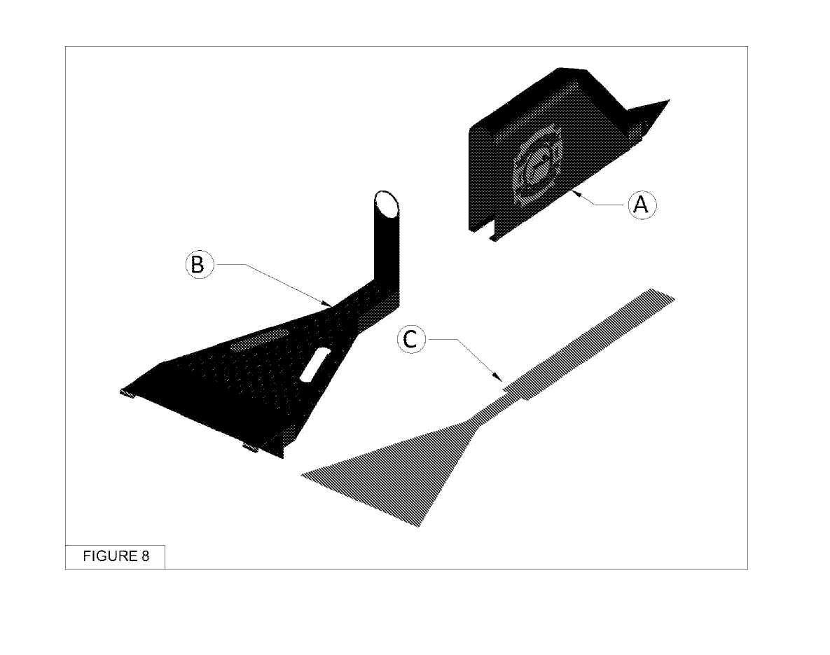

FIG. 8: External body structures.

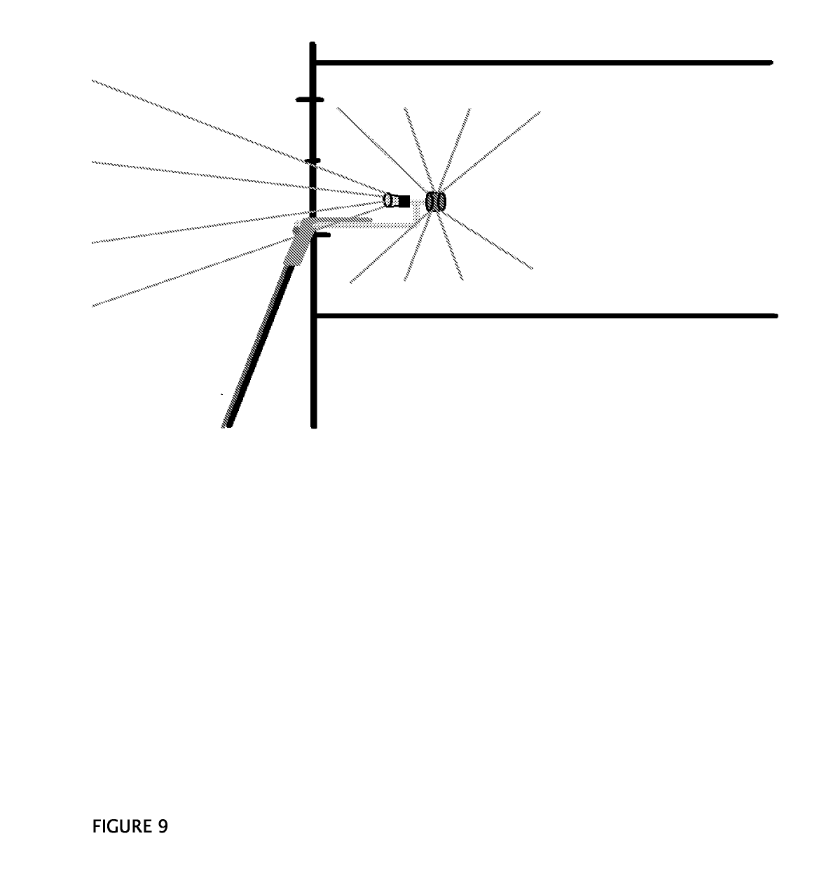

FIG. 9: Graphic depiction of Grantham Mechanical Ventilator in use.

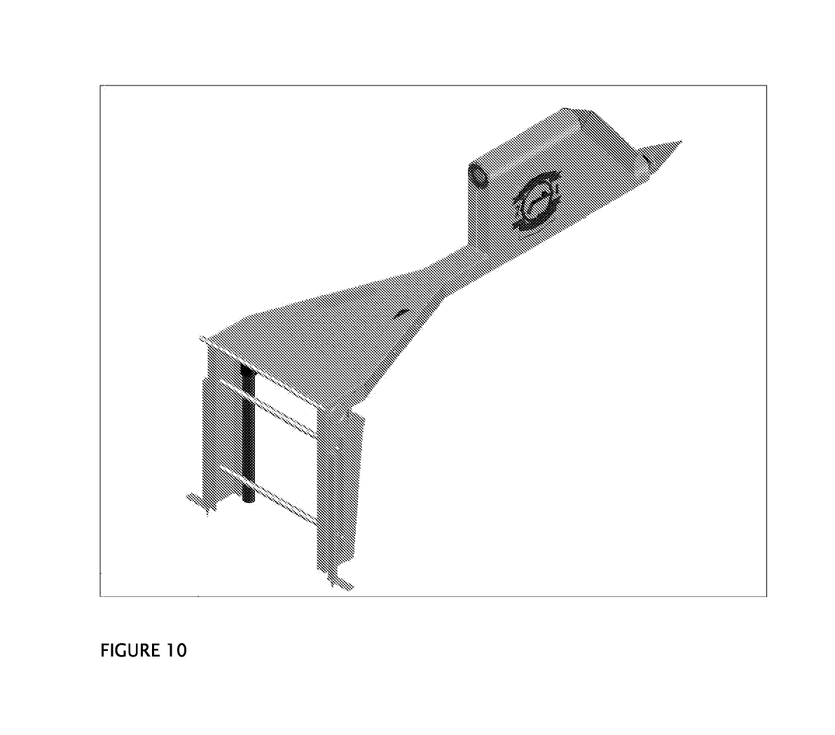

FIG. 10—Device with body pieces in place.

### DETAILED DESCRIPTION OF THE FIGURES

FIG. 1—VIEW FROM TOP RIGHT REAR

A. ENTRY TIP NOZZLE

B. ENTRY NOZZLE CONTROL PULLEY

C. FOG NOZZLE

D. FOG NOZZLE CONTROL PULLEY

E. PIPE/BODY SUPPORT PLATES

F. WATER SUPPLY PIPE

G. CONTROL CABLES

H. CONTROL LEVERS

I. ELECTRIC POWER SUPPLY (12VDC)

J. IMPACT RESISTANT PLATES

K. LADDER RUNG SUPPORT BAR

L. FIRST FLOOR TELESCOPIC GROUND ANCHOR WITH FOOTPLATE

FIG. 2—TOP VIEW

A. ENTRY TIP NOZZLE

B. ENTRY NOZZLE CONTROL PULLEY

C. FOG NOZZLE

D. FOG NOZZLE CONTROL PULLEY

E. PIPE/BODY SUPPORT PLATES

F. WATER SUPPLY PIPE

G. CONTROL CABLES

H. CONTROL LEVERS

I. ELECTRIC POWER SUPPLY (12VDC)

FIG. 3—LEFT SIDE VIEW

A. ENTRY TIP NOZZLE

B. ENTRY NOZZLE CONTROL PULLEY

C. FOG NOZZLE

D. FOG NOZZLE CONTROL PULLEY

E. PIPE/BODY SUPPORT PLATES

F. WATER SUPPLY PIPE

G. CONTROL CABLES

H. CONTROL LEVERS

I. ELECTRIC POWER SUPPLY (12VDC)

J. IMPACT RESISTANT PLATES

K. LADDER RUNG SUPPORT BAR

L. FIRST FLOOR TELESCOPIC GROUND ANCHOR WITH FOOTPLATE

FIG. 4—BOTTOM VIEW

A. ENTRY TIP NOZZLE

B. ENTRY NOZZLE CONTROL PULLEY

C. FOG NOZZLE

D. FOG NOZZLE CONTROL PULLEY

E. PIPE/BODY SUPPORT PLATES

F. WATER SUPPLY PIPE

G. CONTROL CABLES

H. CONTROL LEVERS

I. ELECTRIC POWER SUPPLY (12VDC)

J. IMPACT RESISTANT PLATES

K. LADDER RUNG SUPPORT BAR

L. FIRST FLOOR TELESCOPIC GROUND ANCHOR WITH FOOTPLATE

M. LADDER RUNG SUPPORT BAR RELEASE HANDLE

FIG. 5—RIGHT SIDE VIEW

A. ENTRY TIP NOZZLE

B. ENTRY NOZZLE CONTROL PULLEY

C. FOG NOZZLE

D. FOG NOZZLE CONTROL PULLEY

E. PIPE/BODY SUPPORT PLATES

F. WATER SUPPLY PIPE

G. CONTROL CABLES

H. CONTROL LEVERS

I. ELECTRIC POWER SUPPLY (12VDC)

J. IMPACT RESISTANT PLATES

K. LADDER RUNG SUPPORT BAR

L. FIRST FLOOR TELESCOPIC GROUND ANCHOR WITH FOOTPLATE

M. LADDER RUNG SUPPORT BAR RELEASE HANDLE

N. IMPACT RESISTANT BAR SPRINGS

O. LADDER RUNG SUPPORT BAR ANCHOR SPRINGS

FIG. 6—REAR VIEW

A. ENTRY TIP NOZZLE

B. ENTRY NOZZLE CONTROL PULLEY

C. FOG NOZZLE

D. FOG NOZZLE CONTROL PULLEY

E. PIPE/BODY SUPPORT PLATES

F. WATER SUPPLY PIPE

G. CONTROL CABLES

H. CONTROL LEVERS

I. ELECTRIC POWER SUPPLY (12VDC)

J. IMPACT RESISTANT PLATES

K. LADDER RUNG SUPPORT BAR

L. FIRST FLOOR TELESCOPIC GROUND ANCHOR WITH FOOTPLATE

M. LADDER RUNG SUPPORT BAR RELEASE HANDLE

N. IMPACT RESISTANT BAR SPRINGS

O. LADDER RUNG SUPPORT BAR ANCHOR SPRINGS

P. STATIONARY SUPPORT RETAINING CLIPS WITH RELEASE

Q. 90 DEGREE FEMALE SWIVEL

R. PRE-CONNECTED DOUBLE JACKET FIRE ATTACK HOSE

S. CONTROL LED LIGHTING BLUE

FIG. 7—FRONT VIEW

A. ENTRY TIP NOZZLE

B. ENTRY NOZZLE CONTROL PULLEY

C. FOG NOZZLE

D. FOG NOZZLE CONTROL PULLEY

E. PIPE/BODY SUPPORT PLATES

F. WATER SUPPLY PIPE

G. CONTROL CABLES

H. CONTROL LEVERS

I. ELECTRIC POWER SUPPLY (12VDC)

J. IMPACT RESISTANT PLATES

K. LADDER RUNG SUPPORT BAR

L. FIRST FLOOR TELESCOPIC GROUND ANCHOR WITH FOOTPLATE

M. LADDER RUNG SUPPORT BAR RELEASE HANDLE

N. IMPACT RESISTANT BAR SPRINGS

O. LADDER RUNG SUPPORT BAR ANCHOR SPRINGS

P. STATIONARY SUPPORT RETAINING CLIPS WITH RELEASE

Q. 90 DEGREE FEMALE SWIVEL

R. PRE-CONNECTED DOUBLE JACKET FIRE ATTACK HOSE

FIG. 8—EXTERNAL BODY STRUCTURES

A. HEAD BODY COVER

B. RESCUE PLATE AND TOP COVER

C. BOTTOM PLATE COVER

FIG. 9—Graphic depiction of Grantham Mechanical Ventilator in use.

This figure illustrates the invention mounted at the top of a ladder in a window

opening with the ventilating fog exiting the compartment toward the left and

the fire extinguishing water spraying into the room toward the right.

FIG. 10—Complete body work viewed from above-right rear of device.

This figure illustrates the appearance of the unit with head body cover, rescue

plate and top cover, and bottom plate cover installed.

What is claimed is:

1. (canceled)

2. (canceled)

3. (canceled)

4. (canceled)

5. (canceled)

6. (canceled)

7. (canceled)

8. (canceled)

9. (canceled)

10. A portable pre-entry suppression and ventilation attack tool, sized appropriately to be carried and configured for use by a single firefighter of normal strength and stature, to be used in fighting fires comprising: (1) a means to remove smoke and heat from a burning compartment using hydraulic ventilation through an opening in the compartment; (2) one or more input connectors compatible with standard firefighting hose-line connections; (3) a means to securely attach the tool to the top of a ladder to hold the tool in position for use; (4) a means to securely attach the tool directly to an opening in a burning compartment without requiring a ladder to hold the tool in position for use; (5) a means to douse the fire; and (6) a means to allow firefighters fast emergency egress from a burning compartment.

11. A tool as in claim 10 further comprising a means, located on the tool, to adjust the flow rate and spray pattern of said hydraulic ventilation, from outside of and below said opening in which the tool is located, without having to adjust the water flow at the water source.

12. A tool as in claim 11 further comprising a means to apply water inside of said burning compartment, in multiple spiral streams the width of which are essentially less than 1 inch in diameter, exiting the tool essentially perpendicular to the tool's horizontal axis.

13. A tool as in claim 12 further comprising a means to apply water inside the burning compartment in a stream of variable width and volume, exiting the tool essentially parallel to the tool's horizontal axis.

14. A tool as in claim 13 further comprising a means to apply liquid fire suppressing materials other than water inside the burning compartment, in a stream of variable width and volume, exiting the tool essentially parallel to the tool's horizontal axis.
